(19) United States
(12) Patent Application Publication
(10) Pub. No.: US 2025/0347453 A1
(43) Pub. Date: Nov. 13, 2025

(54) DETECTION AND MITIGATION OF COOLANT LEAKS IN MULTIPLE BRANCH COOLANT SYSTEM

(71) Applicant: GM GLOBAL TECHNOLOGY OPERATIONS LLC, Detroit, MI (US)

(72) Inventors: Justin A. Bunnell, Farmington Hills, MI (US); Andres V. Mituta, Lake Orion, MI (US); Benjamin C. Groen, Troy, MI (US); Philip J. Prociw, Clinton Township, MI (US); Jeffrey A. Bednar, South Lyon, MI (US)

(73) Assignee: GM GLOBAL TECHNOLOGY OPERATIONS LLC, Detroit, MI (US)

(21) Appl. No.: 18/662,223

(22) Filed: May 13, 2024

(51) Int. Cl. F25B 49/00; H01M 10/613

(52) U.S. Cl. CPC F25B 49/005; H01M 10/613; F25B 2500/222; F25B 2600/2507; F25B 2600/2515

(57) ABSTRACT

A coolant leak detection and mitigation system for a rechargeable energy storage system having multiple battery cells arranged in individual battery modules includes a cooling system having a main coolant loop and multiple parallel coolant branches. Each coolant branch adjusts the temperature of one battery module using a portion of coolant from the main coolant loop. The cooling system also has flow-valve(s) for regulating and distributing the coolant from the main coolant loop across the coolant branches. An electronic controller is configured to monitor the cooling system for coolant loss and, in response to an indication of coolant loss, assess each coolant branch for a coolant leak. The controller is also configured to identify a coolant branch having a coolant leak and shut off, via the flow-valve(s), coolant flow into the coolant branch having the coolant leak.

The present disclosure relates to detection and mitigation of coolant leaks in a multiple branch coolant system for a multi-cell rechargeable energy storage system (RESS).

Typically, an electric energy generation and storage battery system includes one or more battery cells for powering a load. A plurality of battery cells may be arranged in close proximity to one another to generate a battery module and a plurality of battery modules may be organized into a battery pack array. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Exposure of a battery cell to elevated temperatures over prolonged periods may cause the cell to experience a thermal runaway event, where heat build-up in an individual cell leads to the heat spreading to adjacent cells in the module and affecting the entire battery array. Accordingly, thermal energy needs to be effectively removed to mitigate heat build-up and consequent degradation of battery system performance. Generally, devices such as heat-sinks or cold-plates with circulating coolant are employed to remove heat from battery systems.

### SUMMARY

A coolant leak detection and mitigation system for a multi-cell rechargeable energy storage system (RESS) having a plurality of battery cells arranged in individual battery modules includes a cooling system. The cooling system has a main coolant loop configured to circulate coolant. The cooling system also has a plurality of coolant branches arranged fluidly in parallel. Each coolant branch is configured to receive a portion of the coolant from the main coolant loop to adjust the temperature of one of the respective battery modules. The cooling system additionally has at least one flow-valve configured to regulate and distribute across the plurality of coolant branches the coolant circulated through the main coolant loop.

The leak detection and mitigation system also includes an electronic controller configured to monitor the cooling system for an indication of coolant loss. The controller is also configured to assess each of the plurality of coolant branches for a coolant leak in response to the indication of coolant loss. The controller is additionally configured to identify a coolant branch, from among the plurality of coolant branches, having a coolant leak. The controller is further configured to shut off, via the flow-valve(s), a flow of the coolant into the coolant branch having the coolant leak.

The electronic controller may be additionally configured to set an alert indicative of the coolant branch having the coolant leak and the flow of the coolant having been shut off.

The main coolant loop may include a reservoir configured to supply the coolant and having a coolant level sensor in communication with the electronic controller. In such an embodiment, the indication of coolant loss in the coolant system may be signified by a reduction of coolant level or volume in the reservoir.

The electronic controller may be configured to assess each of the plurality of coolant branches for a coolant leak via detection of loss of coolant pressure in each corresponding coolant branch.

The detection of loss of coolant pressure in each coolant branch may be accomplished via detection of coolant pressure in an individual coolant branch upstream of the respective battery module and determination of coolant pressure in the subject coolant branch downstream of the subject battery module.

Each coolant branch may include a one-way valve configured to control the flow of the coolant out of the subject coolant branch and in communication with the electronic controller. In such an embodiment, the detection of loss of coolant pressure in each coolant branch may be accomplished via detection of coolant pressure in an individual coolant branch upstream of the respective battery module and determination of the response of a corresponding one-way valve to the detected coolant pressure upstream of the subject battery module.

Each coolant branch may include a valve displacement sensor in communication with the electronic controller. In such an embodiment, the response of each one-way valve may be determined via the valve displacement sensor.

The electronic controller may be programmed with a look-up table of displacement of the corresponding one-way valve versus coolant pressure in an individual coolant branch upstream of the respective battery module.

The cooling system may also include a fluid pump configured to circulate the coolant through the main coolant loop.

Each coolant branch may include a coolant flow sensor downstream of the corresponding battery module and in communication with the electronic controller. In such an embodiment, the electronic controller may be further configured to assess each of the plurality of coolant branches for a coolant leak via determination of the amount of coolant flow therethrough using the corresponding coolant flow sensor.

The flow-valve may be a multi-way valve assembly arranged in a junction between the main coolant loop and the plurality of coolant branches. Such a multi-way valve may be configured to control the flow of the coolant into each of the coolant branches.

Alternatively, a plurality of throttle valves may regulate the flow of the coolant from the main coolant loop. Each throttle valve may be arranged in one of the coolant branches upstream of the corresponding battery module and be configured to control the flow of the coolant into the subject coolant branch.

A motor vehicle employing a coolant leak detection and mitigation system, as described above, and a method of detecting and mitigating a coolant leak in a multi-cell rechargeable energy storage system (RESS) are also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a multi-cell rechargeable energy storage system (RESS) configured to generate and store electrical energy used by vehicle systems including the power-sources, according to the disclosure.

FIG. 2 is a schematic illustration of the RESS shown in FIG. 1, including an embodiment of a coolant system having a main coolant loop and multiple parallel coolant branches subsystem for removing thermal energy from individual battery modules and individual coolant pressure sensors for detecting coolant leaks within the coolant branches, according to the disclosure.

FIG. 3 is a schematic illustration of the RESS shown in FIG. 1, including another embodiment of a coolant system having a main coolant loop and multiple parallel coolant branches subsystem for removing thermal energy from individual battery modules and individual coolant flow sensors for detecting coolant leaks within the coolant branches, according to the disclosure.

FIG. 4 illustrates a method of detecting and mitigating a coolant leak in the multi-cell RESS shown in FIGS. 1-3.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

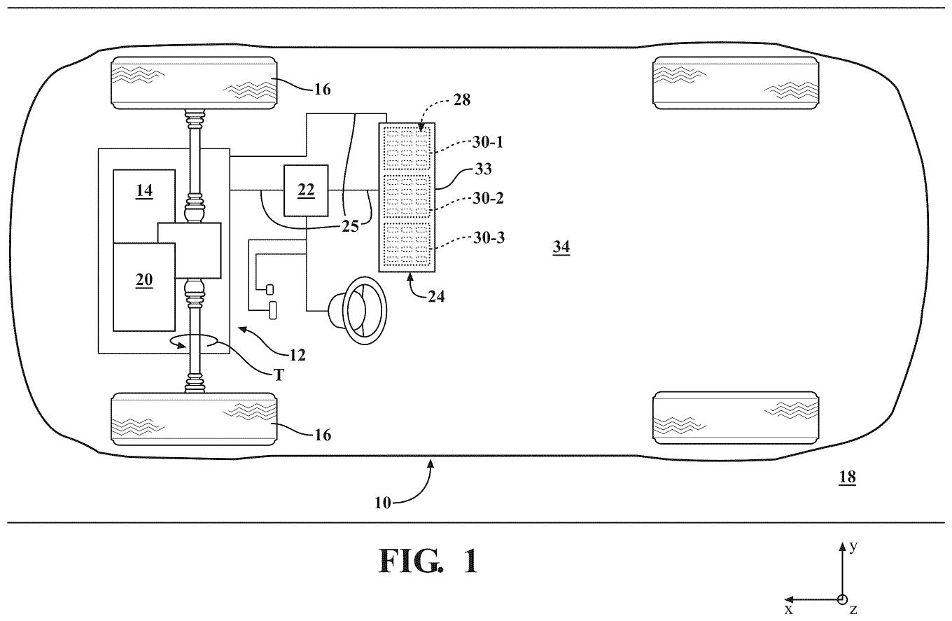

Referring to the drawings, wherein like reference numbers refer to like components, FIG. 1 shows a schematic view of a motor vehicle 10 having a powertrain 12. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may include an additional power-source 20, such as an internal combustion engine. The power-sources 14 and 20 may act in concert to power the vehicle 10. The vehicle 10 additionally includes a central processing unit (CPU) 22 and a multi-cell rechargeable energy storage system (RESS) 24 configured to generate and store electrical energy through heat-producing electro-chemical reactions for supplying the electrical energy to the power-sources 14 and 20. The CPU 22 regulates various systems of the vehicle 10, including the powertrain 12 to generate a predetermined amount of power-source torque T. The RESS 24 may be connected to the power-sources 14 and 20, to the electronic CPU 22, as well as to other vehicle systems via a high-voltage databus or BUS 25.

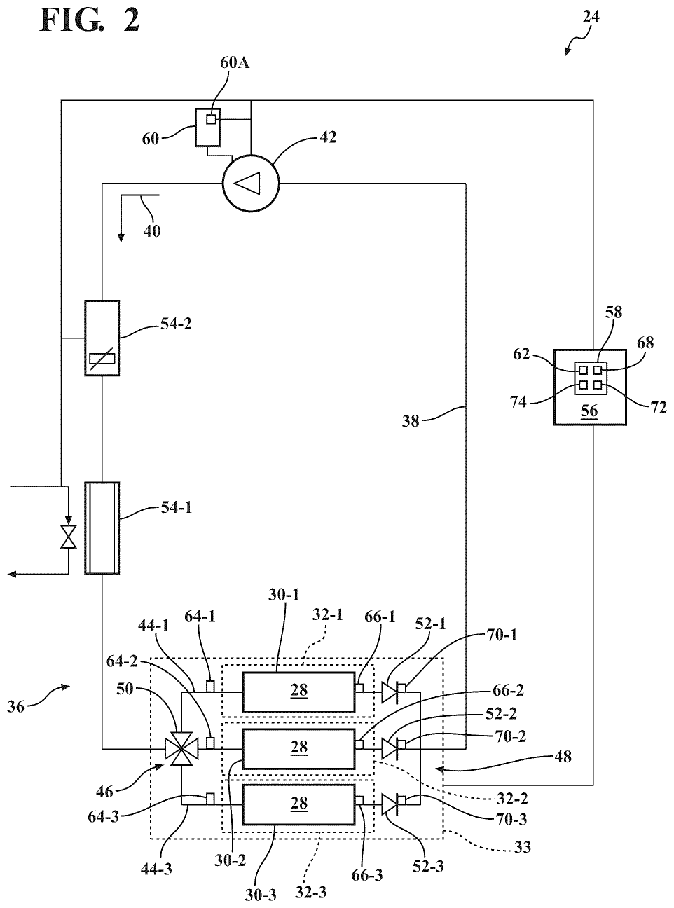

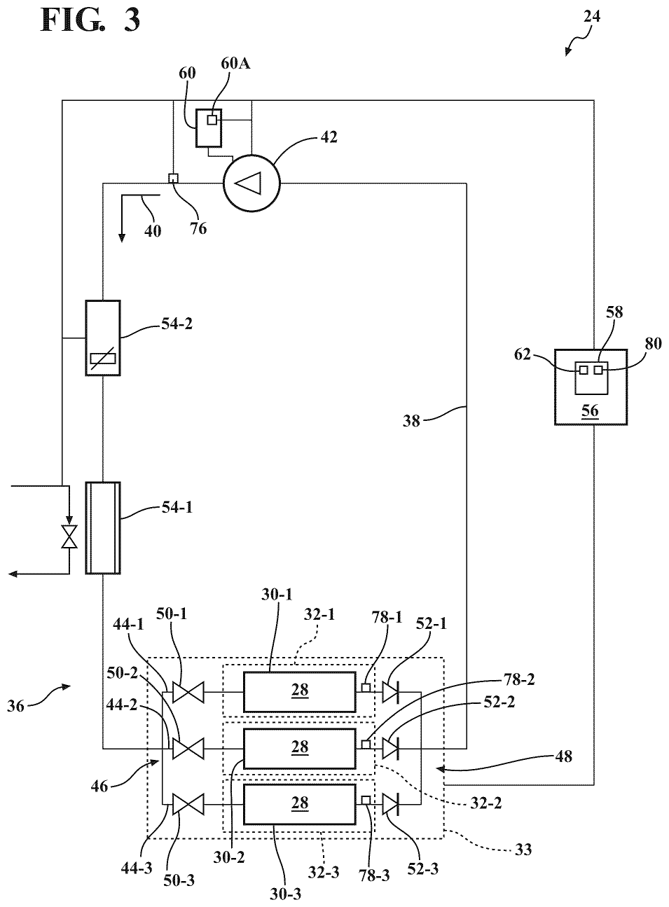

As shown in FIGS. 1-3, the RESS 24 includes a plurality of battery cells 28 arranged in individual battery groups or modules, such as a first module 30-1, a second module 30-2, and a third module 30-3. The subject modules 30-1, 30-2, 30-3 may be arranged electrically in series or in parallel. Although three individual battery modules are specifically shown, it is intended that the RESS 24 includes at least two respective modules, and multiple modules may be organized into battery packs or subpacks. The remainder of the present description will focus on RESS 24 construction having three battery modules 30-1, 30-2, 30-3, with each battery module having a desired quantity of battery cells 28. As shown in FIGS. 2 and 3, each battery module 30-1, 30-2, 30-3 includes a respective battery module enclosure 32-1, 32-2, 32-3 connected to chassis ground and configured to house and support the corresponding battery cells 28. The RESS 24 may also include a battery pack enclosure 33 surrounded by an ambient environment 34 and configured to house and support the battery modules 30-1, 30-2, 30-3 (shown in FIG. 1).

As shown in FIGS. 2 and 3, RESS 24 also includes a cooling system 36 configured to remove thermal energy from various temperature sensitive components of the RESS. Cooling system 36 includes a main coolant loop 38 configured to circulate a coolant 40 through the RESS 24. As shown, cooling system 36 further includes a fluid pump 42 configured to circulate coolant 40 through the main coolant loop 38. The cooling system 36 also includes a plurality of coolant branches, shown as a first branch 44-1, a second branch 44-2, and a third branch 44-3, in fluid communication with the main coolant loop 38. Each of the coolant branches 44-1, 44-2, 44-3 extends through a respective battery module 30-1, 30-2, 30-3, proximate and along the constituent battery cells 28.

Furthermore, each coolant branch 44-1, 44-2, 44-3 is configured to receive a portion of the coolant 40 from the main coolant loop 38. The coolant branches 44-1, 44-2, 44-3 are arranged fluidly in parallel to receive respective portions of the coolant 40. The coolant branches 44-1, 44-2, 44-3 are thereby configured to independently circulate their respective portions of the coolant 40 and adjust the temperature of the corresponding battery modules 30-1, 30-2, 30-3 (by removing or adding thermal energy). Accordingly, each coolant branch 44-1, 44-2, 44-3 passes through one of the battery module enclosures 32-1, 32-2, 32-3. As shown, the main coolant loop 38 may be in fluid communication with additional parallel coolant branches, for example to circulate the coolant through auxiliary power modules (APMs), a Battery Disconnect Unit (BDU) including various electrical switches and relays, electrical connectors, a DC/DC converter for supplying 12V/48V power to the vehicle, etc., each having a particular temperature requirement.

With continued reference to FIGS. 2 and 3, the RESS 24 may also include an inlet manifold 46 configured to connect the main coolant loop 38 to the coolant branches 44-1, 44-2, 44-3 and an outlet manifold 48 configured to connect the coolant branches back to the main coolant loop. Accordingly, the inlet and outlet manifolds 46, 48 are together configured to maintain circulation of coolant 40 through the cooling system 36. The cooling system 36 additionally includes at least one flow-valve 50. The flow-valve(s) 50 are configured to regulate and distribute across the individual coolant branches 44-1, 44-2, 44-3, the coolant 40 circulated through and received from the main coolant loop 38. In other words, the flow-valve(s) 50 are specifically structured and operated to provide independent regulation of coolant flow into each individual coolant branch 44-1, 44-2, 44-3.

As shown in FIG. 2, the flow-valve 50 may be a multi-way valve assembly arranged in a junction, such as the inlet manifold 46, between the main coolant loop 38 and the plurality of coolant branches 44-1, 44-2, 44-3 upstream of each battery module 30-1, 30-2, 30-3. The multi-way valve assembly embodiment of the flow-valve 50 may be configured to control the flow of coolant 40 into each of the coolant branches 44-1, 44-2, 44-3. As shown in FIG. 3, the flow-valve(s) 50 may be a plurality of individual throttle valves 50-1, 50-2, 50-3. Each subject throttle valve 50-1, 50-2, 50-3 may be arranged in one of the plurality of coolant branches 44-1, 44-2, 44-3 upstream of the corresponding battery module 30-1, 30-2, 30-3 and configured to control the flow of the coolant 40 into the subject coolant branch.

As shown in FIGS. 2 and 3, each coolant branch 44-1, 44-2, 44-3 may include a respective one-way valve 52-1, 52-2, 52-3. The one-way valves 52-1, 52-2, 52-3 are configured to prevent backflow of the coolant 40 into the corresponding coolant branches 44-1, 44-2, 44-3. Each of the one-way valves 52-1, 52-2, 52-3 is arranged aft of the flow-valve(s) 50 and downstream of the corresponding battery module 30-1, 30-2, 30-3. Accordingly, each one-way valve 52-1, 52-2, 52-3 is configured to control the flow of the corresponding portion of the coolant 40 through and out of the subject coolant branch 44-1, 44-2, 44-3. Cooling system 36 may also include a plurality of heat exchangers arranged in the main coolant loop 38 to alter the temperature of the coolant 40. For example, one embodiment of such a heat exchanger may be a coolant chiller 54-1, for example, using a refrigerant, to remove thermal energy from the coolant 40 in the main coolant loop 38. Another embodiment of such a heat exchanger may be a coolant heater 54-2, for example, using electrical resistance, to add thermal energy to the coolant 40.

As shown in FIGS. 2 and 3, the multi-cell RESS 24 may additionally include an electronic controller 56 that may be either electronically connected to or be part of the CPU 22. The electronic controller 56 may be configured or programmed to regulate operation of the cooling system 36 or be structured to manage operation of the RESS 24 as a whole. As shown, the electronic controller 56 is in operative communication with the fluid pump 42, the flow-valve(s) 50, the coolant chiller 54-1, and the coolant heater 54-2. To support requisite management of the RESS 24 and/or the cooling system 36, the electronic controller 56 specifically includes a processor and tangible, non-transitory memory, which includes requisite instructions programmed therein. The controller's memory may be an appropriate recordable medium that participates in providing computer-readable data or process instructions. Such a recordable medium may take many forms, including but not limited to non-volatile media and volatile media.

Non-volatile media for electronic controller 56 may include, for example, optical or magnetic disks and other persistent memory. Volatile media may include, for example, dynamic random-access memory (DRAM), which may constitute a main memory. The instructions programmed into the controller 56 may be transmitted by one or more transmission medium, including coaxial cables, copper wire and fiber optics, including the wires that comprise a system bus coupled to a processor of a computer, or via a wireless connection. Memory of the electronic controller 56 may also include a flexible disk, hard disk, magnetic tape, another magnetic medium, a CD-ROM, DVD, another optical medium, etc. The electronic controller 56 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry.

The electronic controller 56 may be configured to regulate the flow of coolant 40 into the individual battery modules 30-1, 30-2, 30-3 via the fluid pump 42 and the flow-valve(s) 50. Algorithm(s), indicated generally via numeral 58, required by the electronic controller 56 or accessible thereby may be stored in the memory of the controller and automatically executed to facilitate operation of the RESS 24 and/or the cooling system 36. Specifically, the algorithm(s) 58 include an inventory mode configured to monitor the amount of coolant 40 present in the cooling system 36 during operation of the RESS 24. For example, a measurable depletion of the coolant 40 in the main coolant loop 38 may be used as an indication of coolant loss somewhere in the cooling system 36.

As shown in FIGS. 2-3, the main coolant loop 38 may include a reservoir 60 configured to supply the coolant 40 to the fluid pump 42. The reservoir 60 may include a coolant level sensor 60A in operative communication with the electronic controller 56. A measurable or significant decrease of coolant level or volume in the reservoir 60 may be an indicator of coolant loss in the coolant system 36. The coolant level sensor 60A may continuously or periodically communicate the level of coolant 40 in the reservoir 60 to the electronic controller 56 and based on the sensor signal the controller 56 may determine whether coolant has been lost. In response to a detected loss of coolant in the main coolant loop 38, the electronic controller 56 may trigger an assessment of each coolant branch 44-1, 44-2, 44-3 for a coolant leak. The coolant branches 44-1, 44-2, 44-3 may be monitored or assessed for coolant leaks continuously, at regular time intervals, or at every key-on of the vehicle 10.

The electronic controller 56 is specifically programmed to identify one or more coolant branches from among the branches present in the cooling system 36, e.g., branches 44-1, 44-2, and 44-3, that are affected by a coolant leak. For example, the coolant branch 44-1 may be recognized as having the coolant leak. In such a case, the controller 56 will shut off the flow of coolant 40 into the coolant branch with the identified leak via the corresponding flow-valve(s) 50. In such a case, the coolant flow may be shut off to the branch 44-1 using the multi-way valve 50 or the throttle valve 50-1. The electronic controller 56 may be additionally configured to set, i.e., command or trigger, an alert 62 indicative of the coolant branch having the coolant leak and the flow of the coolant having been shut off to that branch. In other words, the alert 62 may inform a system user or a technician directly via a sensory signal or a trouble code or via a remote server (not shown) that a specific coolant branch is compromised and coolant flow therethrough has been blocked. In the event coolant loss is detected in the cooling system 36 but no coolant leak is identified in the coolant branches 44-1, 44-2, 44-3, the electronic controller 56 may be additionally configured to shut off operation of the fluid pump 42 and trigger an alert indicative of general system coolant loss.

In one embodiment (shown in FIG. 2), the electronic controller 56 may be configured to assess each of the plurality of coolant branches 44-1, 44-2, 44-3 for a coolant leak via detection of loss of coolant pressure in each corresponding coolant branch. Specifically, coolant pressure may be detected in each coolant branch 44-1, 44-2, 44-3 upstream of the corresponding battery module 30-1, 30-2, 30-3 using a respective first coolant pressure sensor 64-1, 64-2, or 64-3 (in communication with the electronic controller 56). Additionally, coolant pressure may be detected in each coolant branch 44-1, 44-2, 44-3 downstream of the corresponding battery module 30-1, 30-2, 30-3 using a respective second coolant pressure sensors 66-1, 66-2, or 66-3 (also in communication with the electronic controller 56). The determination of loss of coolant pressure in a particular coolant branch 44-1, 44-2, 44-3 would then be based on the corresponding difference between the detected coolant pressures upstream and downstream of the particular battery module 30-1, 30-2, 30-3. Specifically, the determined pressure difference exceeding a predetermined value 68 would be considered as indicative of a coolant leak in the corresponding coolant branch 44-1, 44-2, or 44-3.

In another embodiment (also shown in FIG. 2), the electronic controller 56 may be configured to assess each of the plurality of coolant branches 44-1, 44-2, 44-3 for a coolant leak using the corresponding one-way valves 52-1, 52-2, 52-3. Specifically, coolant pressure may be detected in each coolant branch 44-1, 44-2, 44-3 upstream of the corresponding battery module 30-1, 30-2, 30-3 via the respective first coolant pressure sensor 64-1, 64-2, or 64-3. Additionally, a response of the corresponding one-way valve 52-1, 52-2, 52-3 to the detected coolant pressure upstream of the subject battery module may be detected in each coolant branch 44-1, 44-2, 44-3. For example, the response of each one-way valve 52-1, 52-2, 52-3 may be a position of the valve, e.g., fully open versus closed.

In the above construction, if the one-way valve opens under prescribed coolant pressure, the assessment would be that there is no loss of coolant pressure, and accordingly no leak in the subject coolant branch 44-1, 44-2, or 44-3. On the other hand, if the one-way valve doesn't open or opens too little, the assessment would be that the corresponding coolant branch may have a leak. In another example, the response of each one-way valve 52-1, 52-2, 52-3 may be determined via a corresponding valve displacement sensor 70-1, 70-2, 70-3 configured to communicate its measurement with the electronic controller 56. In such a construction, if the displacement of a specific one-way valve 52-1, 52-2, 52-3 under prescribed coolant pressure is within a predetermined displacement range 72, the assessment would be that there is no leak in the subject coolant branch 44-1, 44-2, or 44-3. On the other hand, if the displacement of a specific one-way valve 52-1, 52-2, 52-3 under prescribed coolant pressure is outside the predetermined displacement range 72 (too small of a valve opening), the assessment would be that the corresponding coolant branch may have a leak. The electronic controller 56 may be programmed with a look-up table 74 (shown in FIG. 2). The look-up table 74 is intended to include displacement of the corresponding one-way valves 52-1, 52-2, 52-3 versus coolant pressure values in an individual coolant branch 44-1, 44-2, 44-3 upstream of the respective battery module 30-1, 30-2, 30-3.

The flow of coolant 40 in the main coolant loop 38 may be detected via a main coolant flow sensor 76 (shown in FIG. 3) and communicated to the electronic controller 56. Each coolant branch 44-1, 44-2, 44-3 may include a respective coolant flow sensor 78-1, 78-2, 78-3 downstream of the corresponding battery module 30-1, 30-2, 30-3 and in communication with the electronic controller 56. As shown in FIG. 3, the electronic controller 56 may be configured to assess each of the coolant branches 44-1, 44-2, 44-3 for a coolant leak via determination of an amount of coolant flow therethrough. A decrease in coolant flow in comparison to the flow in the main coolant loop 38 may be determined by the electronic controller 56 based on the apportioned flow through the coolant branches and using the corresponding coolant flow sensors 78-1, 78-2, 78-3 and the main coolant flow sensor 76. In such a construction, if the coolant flow detected by the coolant flow sensor 78-1, 78-2, 78-3 under prescribed coolant flow is within a predetermined flow range 80, the assessment would be that there is no leak in the subject coolant branch 44-1, 44-2, or 44-3. On the other hand, if the coolant flow detected by the coolant flow sensor 78-1, 78-2, 78-3 under prescribed coolant pressure is outside the predetermined flow range 80, the assessment would be that the corresponding coolant branch may have a leak.

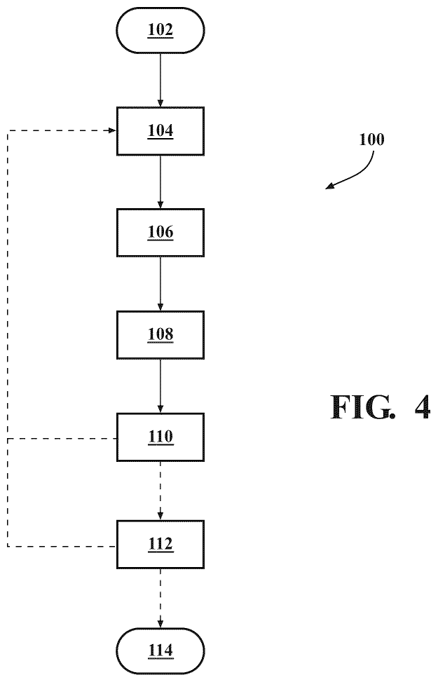

A method 100 of detecting and mitigating a coolant leak in a multi-cell rechargeable energy storage system, such as the RESS 24, as shown in FIG. 4 and described below with reference to the structure shown in FIGS. 1-3. The method is specifically for use in the RESS employing a main coolant loop connected to a fluid pump, e.g., the main coolant loop 38 and a plurality of coolant branches, such as branches 44-1, 44-2, 44-3, arranged in parallel, each configured to receive a portion of the coolant 40 from the main coolant loop. The subject RESS also employs at least one flow-valve 50 configured to regulate and distribute the coolant 40 received from main coolant loop 38 across the plurality of coolant branches 44-1, 44-2, 44-3.

Method 100 commences in frame 102 with regulating, via the electronic controller 56, flow of coolant 40 in the main coolant loop 38 of the cooling system 36. After frame 102, the method proceeds to frame 104. In frame 104 the method includes monitoring, via the electronic controller 56, the cooling system 36 for an indication of coolant loss. As described above with respect to FIGS. 2-3, the indication of coolant loss in the coolant system 36 may be a reduction of coolant volume or level in the reservoir 60. Following frame 104, the method advances to frame 106. In frame 106, the method includes assessing, via the electronic controller 56, each of the coolant branches 44-1, 44-2, 44-3 for a coolant leak in response to the indication of coolant loss in the cooling system 36. As described above with respect to FIG. 2, assessment of the coolant branches 44-1, 44-2, 44-3 for a coolant leak may include detecting a loss of coolant pressure or flow in each corresponding coolant branch.

After frame 106, the method moves on to frame 108. In frame 108 the method includes identifying, via the electronic controller 56, from among the branches 44-1, 44-2, 44-3, a coolant branch having a coolant leak. For example, the coolant pressure may be detected in an individual coolant branch 44-1, 44-2, or 44-3 upstream of the respective battery module 30-1, 30-2, 30-3 via a corresponding first coolant pressure sensor 64-1, 64-2, 64-3. The coolant pressure may also be detected in the same coolant branch 44-1, 44-2, 44-3 downstream of the corresponding battery module 30-1, 30-2, 30-3 using a corresponding second coolant pressure sensor 66-1, 66-2, 66-3. As described above relative to FIG. 2, the difference between the upstream and downstream coolant pressures may then be used to identify the coolant branch with the leak.

Alternatively, the coolant pressure may be detected in coolant branches 44-1, 44-2, or 44-3 upstream of the battery modules 30-1, 30-2, 30-3 via the first coolant pressure sensors 64-1, 64-2, 64-3 and a response of the one-way valves 52-1, 52-2, 52-3 may be detected to the upstream coolant pressure. The detected response of the one-way valves 52-1, 52-2, 52-3 may be a position of the valve or its measured displacement, such as via the corresponding valve displacement sensors 70-1, 70-2, 70-3. In another alternative, assessment of a coolant leak in the coolant branches 44-1, 44-2, 44-3 may be accomplished by determining an amount of coolant flow through the respective branches via the corresponding coolant flow sensors 78-1, 78-2, 78-3 and compared to the coolant flow through the main coolant loop 38 detected by the main coolant flow sensor 76.

Following frame 108, the method advances to frame 110. In frame 110, the method includes shutting off, via the flow-valve(s) 50 regulated by the electronic controller 56, the flow of the coolant 40 into the coolant branch 44-1, 44-2, or 44-3 identified as being affected by the coolant leak. After frame 110, the method may proceed to frame 112. In frame 112, following shutting off the coolant flow into the coolant branch affected by the leak, the method includes setting, via the electronic controller 56, the alert 62 signaling the detected existence of the coolant leak. The alert 62 may identify the affected coolant branch and/or the fact that the flow of the coolant has been shut off. Such an alert may be saved in the memory of electronic controller 56 for subsequent retrieval by a technician and/or communicated to a remote server.

Following either frame 110 or frame 112, the method may loop back to frame 104 for continued monitoring of coolant status in the cooling system 36. If, on the other hand no leak is identified in the coolant branches 44-1, 44-2, 44-3, the method may repeat the assessment of the coolant branches in frame 106 or trigger an alert indicative of general coolant loss in the system 36. Otherwise, if the electrical load on the RESS 24 has been removed, e.g., the vehicle 10 has come to a stop, the power-sources 14 and 20 have been switched off, and the fluid pump 42 has been deactivated, the method may conclude in frame 114.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A coolant leak detection and mitigation system for a multi-cell rechargeable energy storage system (RESS) having a plurality of battery cells arranged in individual battery modules, the coolant leak detection and mitigation system comprising:
a cooling system including:
a main coolant loop configured to circulate coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop; and
an electronic controller in operative communication with the cooling system and configured to:
monitor the cooling system for an indication of coolant loss;
assess each of the plurality of coolant branches for a coolant leak in response to the indication of coolant loss;
identify a coolant branch, from among the plurality of coolant branches, having a coolant leak; and
shut off, via the at least one flow-valve, a flow of the coolant into the coolant branch having the coolant leak.

2. The coolant leak detection and mitigation system of claim 1, wherein the electronic controller is additionally configured to set an alert indicative of the coolant branch having the coolant leak and the flow of the coolant having been shut off.

3. The coolant leak detection and mitigation system of claim 1, wherein the main coolant loop includes a reservoir configured to supply the coolant and having a coolant level sensor in communication with the electronic controller, and wherein the indication of coolant loss in the coolant system is a reduction of coolant in the reservoir.

4. The coolant leak detection and mitigation system of claim 1, wherein the electronic controller is configured to assess each of the plurality of coolant branches for a coolant leak via detection of loss of coolant pressure in each corresponding coolant branch.

5. The coolant leak detection and mitigation system of claim 4, wherein the detection of loss of coolant pressure in each coolant branch is accomplished via:
detection of coolant pressure in an individual coolant branch upstream of the respective battery module; and
determination of coolant pressure in the subject coolant branch downstream of the subject battery module.

6. The coolant leak detection and mitigation system of claim 4, wherein each coolant branch includes a one-way valve configured to control a flow of the coolant out of the subject coolant branch and in communication with the electronic controller, and wherein the detection of loss of coolant pressure in each coolant branch is accomplished via:
detection of coolant pressure in an individual coolant branch upstream of the respective battery module; and
determination of response of a corresponding one-way valve to the detected coolant pressure upstream of the subject battery module.

7. The coolant leak detection and mitigation system of claim 6, wherein each coolant branch includes a valve displacement sensor in communication with the electronic controller, and wherein the response of each one-way valve is determined via the valve displacement sensor.

8. The coolant leak detection and mitigation system of claim 7, wherein the electronic controller is programmed with a look-up table of displacement of the corresponding one-way valve versus coolant pressure in an individual coolant branch upstream of the respective battery module.

9. The coolant leak detection and mitigation system of claim 1, wherein each coolant branch includes a coolant flow sensor downstream of the corresponding battery module and in communication with the electronic controller, and wherein the electronic controller is configured to assess each of the plurality of coolant branches for a coolant leak via determination of an amount of coolant flow therethrough using the corresponding coolant flow sensor.

10. The coolant leak detection and mitigation system of claim 1, wherein the at least one flow-valve is one of:
a multi-way valve assembly arranged in a junction between the main coolant loop and the plurality of coolant branches and configured to control a flow of the coolant into each of the coolant branches; and
a plurality of throttle valves, each throttle valve arranged in one of the plurality of coolant branches upstream of the corresponding battery module and configured to control a flow of the coolant into the subject coolant branch.

11. A method of detecting and mitigating a coolant leak in a multi-cell rechargeable energy storage system (RESS) having a plurality of battery cells arranged in individual battery modules, the method comprising:
regulating, via an electronic controller, a flow of coolant in a cooling system, wherein the cooling system includes:
a main coolant loop configured to circulate the coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop; and
monitoring, via the electronic controller, the cooling system for an indication of coolant loss;
assessing, via the electronic controller, each of the plurality of coolant branches for a coolant leak in response to the indication of coolant loss in the cooling system;
identifying, via the electronic controller, a coolant branch, from among the plurality of coolant branches, having a coolant leak; and
shutting off, via the electronic controller using the at least one flow-valve, a flow of the coolant into the coolant branch having the coolant leak.

12. The method of claim 11, further comprising setting, via the electronic controller, an alert indicative of the coolant branch having the coolant leak and the flow of the coolant having been shut off.

13. The method of claim 11, wherein the main coolant loop includes a reservoir configured to supply the coolant and having a coolant level sensor in communication with the electronic controller, and wherein the indication of coolant loss in the coolant system is a reduction of coolant in the reservoir.

14. The method of claim 11, wherein assessing each of the plurality of coolant branches for a coolant leak includes detecting a loss of coolant pressure in each corresponding coolant branch.

15. The method of claim 14, wherein detecting the loss of coolant pressure in each coolant branch includes:
detecting coolant pressure in an individual coolant branch upstream of the respective battery module; and
determining coolant pressure in the subject coolant branch downstream of the subject battery module.

16. The method of claim 14, wherein each coolant branch includes a one-way valve configured to control a flow of the coolant out of the subject coolant branch and in communication with the electronic controller, and wherein the detecting the loss of coolant pressure in each coolant branch includes:
detecting coolant pressure in an individual coolant branch upstream of the respective battery module; and
determining a response of a corresponding one-way valve to the detected coolant pressure upstream of the subject battery module.

17. The method of claim 16, wherein each coolant branch includes a valve displacement sensor in communication with the electronic controller, and wherein determining the response of each one-way valve is achieved via the valve displacement sensor.

18. The method of claim 17, wherein the electronic controller is programmed with a look-up table of displacement of the corresponding one-way valve versus coolant pressure in an individual coolant branch upstream of the respective battery module.

19. The method of claim 11, wherein each coolant branch includes a coolant flow sensor downstream of the corresponding battery module and in communication with the electronic controller, and wherein assessing each of the plurality of coolant branches for a coolant leak includes determining an amount of coolant flow therethrough using the corresponding coolant flow sensor.

20. A motor vehicle comprising:
an electric motor-generator configured to generate torque;
a multi-cell rechargeable energy storage system (RESS) configured to supply electrical energy to the electric motor-generator, the RESS including:
a plurality of battery cells arranged in individual battery modules; and
a cooling system including:
a main coolant loop configured to circulate coolant;
a plurality of coolant branches arranged in parallel, wherein:
each coolant branch is configured to receive a portion of the coolant from the main coolant loop to adjust temperature of one of the respective battery modules; and
each coolant branch includes a one-way valve configured to control a flow of the coolant out of the subject coolant branch; and
at least one flow-valve configured to regulate and distribute across the plurality of coolant branches the coolant circulated through the main coolant loop; and
an electronic controller in operative communication with the cooling system and configured to:
monitor the cooling system for an indication of coolant loss;
assess each of the plurality of coolant branches for a coolant leak in response to the indication of coolant loss;
identify a coolant branch, from among the plurality of coolant branches, having a coolant leak; and
shut off, via the at least one flow-valve, a flow of the coolant into the coolant branch having the coolant leak.
